(19) United States
(12) Patent Application Publication
(10) Pub. No.: US 2011/0067300 A1
(43) Pub. Date: Mar. 24, 2011

(54) Method and device for packaging and transporting a floral grouping

(76) Inventor: Noam M. Temkin, Payson, UT (US)

(21) Appl. No.: 12/586,367

(22) Filed: Sep. 21, 2009

(51) Int. Cl. A01G 5/00; A47G 7/00; B23P 17/04

(52) U.S. Cl. 47/41.13; 47/58.1 CF; 29/428

(57) ABSTRACT

A device for packaging or transporting a floral grouping comprising an elongated member having a top portion and a base portion; a handle coupled to the top portion; and a securing member coupled to the elongated member configured to secure a floral grouping to the elongated member. A method for packaging, packing, or transporting a floral grouping comprising providing an elongated member having a handle coupled to a top portion of the elongated member; positioning a floral grouping adjacent to the elongated member; and wrapping a securing member coupled to the elongated member circumferentially around the floral grouping such that the floral grouping is securely coupled to the elongated member.

### FIELD OF INVENTION

The present invention relates to the packaging and transport of floral groupings, in particular, a device and method for packaging and transporting a floral grouping.

### DESCRIPTION OF THE RELATED ART

Floral groupings, such as floral bouquets, arrangements, and bunches, are typically presented to consumers in supermarkets and other retail stores wrapped in an over-wrap of disposable materials such as foil, plastic, or paper, with the stem portion bunched together with elastics, rubber bands, twist ties, ribbon, tape, or the like. These floral groupings are typically purchased by the supermarket or retail store and arrive pre-arranged and pre-packaged from wholesalers or direct through channels such as the mass market floral industry, bouquet or floral farms.

Upon arriving at the supermarket or retail store, the retailer removes each pre-arranged floral grouping from a box or other transport package and positions them for display. Typically this involves grasping each floral grouping at a lower stem portion, so as to not damage the flowers or blossom. This can prove difficult and time consuming, as in many cases, a retailer must reach toward the bottom portion of each floral grouping. Having to grasp the floral grouping from the bottom portions, or stems, of the floral grouping in many cases forces the retailer to bend over repeatedly, as well as exposing the retailer to thorns, water and slimy plant residues on the stems.

Alternatively, in some floral retailer shops, single flowers and/or plants are presented to consumers who then request a florist to arrange and/or package a floral arrangement according to a specified arrangement. In most cases, this involves wrapping the floral arrangement in a disposable paper or foil and bunching the stems of the arrangement with an elastic tie.

Whether it is a wholesaler or bouquet manufacturer/grower packaging and/or prearranging floral groupings for transport, a retailer unpacking and presenting the floral groupings for sale, or a florist arranging a single floral grouping, each typically involves grasping and/or transporting the floral grouping at the lower portion, on or around the stems. As previously indicated, this can expose a transporter to injury from protruding thorns and water and plant residues on the stem, in addition to forcing packaging personnel to bend over repeatedly.

### BRIEF SUMMARY OF THE INVENTION

Described is a device for packaging, packing, and transporting a floral grouping. The device may comprise an elongated member having a top portion and a base portion; a handle coupled to the top portion; and a securing member coupled to the elongated member configured to secure a floral grouping to the elongated member.

In various embodiments of the invention, the device for packaging and transporting a floral grouping may comprise an elongated member having a top portion and a base portion. The base portion may include a protruding member oriented substantially orthogonal to the longitudinal plane, the longitudinal plane being substantially parallel to the elongated member, thereby resulting in an increased cross-sectional area of the base portion relative to the top portion. The protruding member may be defined at least in part by a flared first edge. A handle may be coupled to the top portion of the elongated member. Further, a securing member may be coupled to the base portion of the elongated member and may be configured to secure a floral grouping to the elongated member.

In another embodiment, there is a method for packaging and transporting a floral grouping. The method may comprise providing an elongated member having a handle coupled to a top portion of the elongated member; positioning a floral grouping adjacent to the elongated member; and securing the floral grouping to the elongated member.

In yet another embodiment, there is a method for manufacturing a floral group packaging and transporting device. The method of manufacturing may comprise: providing an elongated member defined by a top portion and a bottom portion; coupling a handle to the top portion; and coupling a securing member to the base portion.

Other features and advantages of the present invention will become apparent to those in the art through consideration of the ensuing description, the accompanying drawings, and the appended claims.

### BRIEF DESCRIPTION OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIG. 1 illustrates a device and method for transporting and packaging a floral grouping, according to one embodiment of the invention;

FIG. 2 is a side cross-sectional view of a device and method for transporting and packaging a floral grouping, according to one embodiment of the invention;

FIG. 3 illustrates a device and method for transporting and packaging a floral grouping, according to one embodiment of the invention;

FIG. 4 illustrates a device and method for transporting and packaging a floral grouping, according to one embodiment of the invention;

FIG. 5 illustrates a device and method for transporting and packaging a floral grouping, according to one embodiment of the invention; and

FIG. 6 illustrates a device and method for transporting and packaging a floral grouping, according to one embodiment of the invention.

### DETAILED DESCRIPTION

Although the foregoing description contains many specifics, these should not be construed as limiting the scope of the present invention, but merely as providing illustrations of some representative embodiments. Similarly, other embodiments of the invention may be devised that do not depart from the spirit or scope of the present invention. Features from different embodiments may be employed in combination, and may comprise, consist essentially of, or consist of the various elements and features described herein.

Reference will now be made to the drawings. Like elements are identified by like numerals. The drawings are not necessarily to scale.

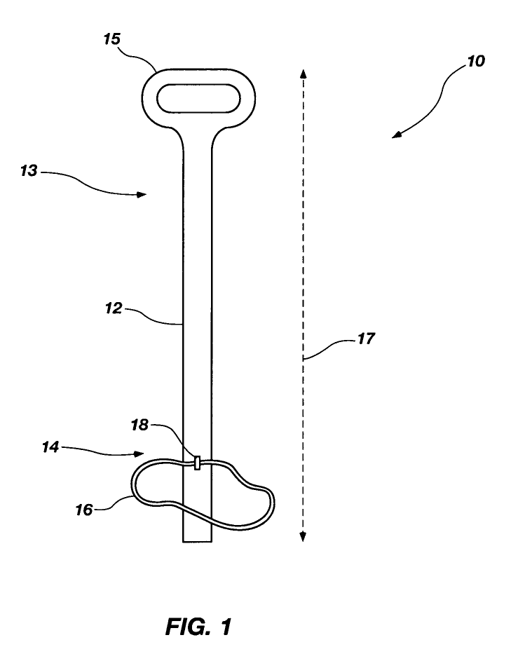

Referring to FIG. 1, there is shown a device 10 for packaging and transporting a floral grouping. The device 10 comprises an elongated member 12 defined by, or including, a top portion 13 and a base portion 14; a handle 15 coupled to the top portion 13; and a securing member 16 coupled to the elongated member 12 configured to secure a floral grouping to the elongated member 12.

Shown in FIG. 1, in one embodiment, the elongated member 12 may be substantially equidistant, or have a substantially uniform width along the length thereof. The width of the elongated member 12 may be defined as being orthogonal to the longitudinal axis 17 and the length of the elongated member 12 may be defined as being parallel to the longitudinal axis 17. In being substantially equidistant, the elongated member 12 need not be exactly equidistant or have an exact uniform width along the length thereof. Additionally, in being substantially equidistant, the elongated member 12 may include one or more portions that are not equidistant along the length thereof.

Also shown in FIG. 1, the device 10 comprises a handle 15 coupled to, or otherwise connected to, the top portion 13 of the elongated member 12. While it is shown that the handle 15 may include a substantially oval shape having an opening therethrough, it is contemplated that the handle 15 may form any shape or size suitable for grasping. In one exemplary embodiment, the handle 15 may be formed or comprise sizes and shapes that are particular to a specific holiday or season, such as, but not limited to, hearts on Valentine's day, pumpkins on Halloween, Christmas ornaments on Christmas, and so forth. Varying the shape of the handle according to a particular season or holiday is particularly advantageous, as it can heighten or augment the effect of an accompanying floral arrangement for a particular occasion.

It is additionally contemplated that the handle 15 and the elongated member 12 may include various designs and writing associated with a particular holiday or occasion, such as, but not limited to Mother's Day, Valentine's Day, Christmas, and so forth. The various designs and writing may be printed upon the device 10, for example, on the handle 15, or the elongated member 12.

It is contemplated that the handle 15 may be coupled to the elongated member 12 in a variety of ways such as, but not limited to, by staples, hooks, adhesive, clips, Velcro®, brads, and so forth. Alternatively, in one embodiment, the handle 15 and the elongated member 12 may be coupled together via a molding process. For example, the handle 15 and the elongated member 12 may be formed or manufactured from one or more molds, or through a molding process, such that the handle 15 and the elongated member 12 are fabricated into a single or continuous piece.

In another alternative embodiment, the handle 15 may be removably coupled to the top portion 13 of the elongated member 12. Removably coupling the handle 15 to the top portion 13 may be accomplished in a variety ways such as through the use of fastening elements, e.g., staples, hooks, adhesive, clips, Velcro®, brads, and so forth.

Illustrated in FIG. 1, the device 10 comprises a securing member 16 coupled to the elongated member 12, the securing member 16 being configured to secure a floral grouping to the elongated member 12. In one embodiment, the securing member 16 is configured to circumferentially wrap around a floral grouping. The securing member 16 can then be tightened such that the floral grouping is secured to the elongated member 12. The securing member 16 may be embodied in a tie, wire, band, ribbon, string, plastic, or equivalents thereof. Further, the securing member 16 may be composed or fabricated, at in least part, of a variety of materials, such as, but not limited to, elastic, wire, plastic, polyurethane, polypropylene rubber, fabric, silk, string, and so forth.

It is contemplated that the securing member 16 may be coupled to the elongated member 12 in a variety of ways, such as by fastening elements 18, e.g., staples, hooks, adhesive, clips, brads, etc.

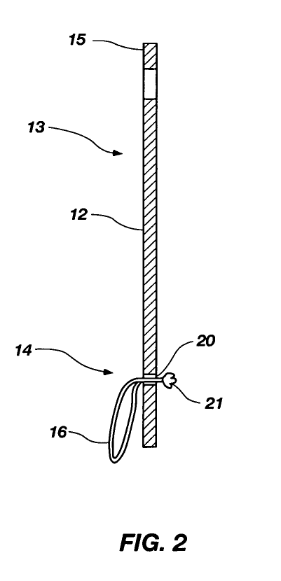

Illustrated in FIG. 2 is a side cross-sectional view of a device 10 for packaging or transporting a floral grouping. As shown, the securing member 16 may extend through the elongated member 12 via a hole 20 in the elongated member 12. The securing member may be secured on an opposing side of the elongated member 12 such that the securing member 16 is prevented from returning back through the hole 20. The securing member 16 may be secured on the opposing side in a variety of ways, such as but not limited to, by a simple knot 21, a fastener, e.g., staples, hooks, adhesive, clips, Velcro®, and so forth.

It is contemplated that the securing member 16 may be coupled to any portion or area of the elongated member 12. In one non-limiting example, shown in FIG. 1, the securing member 16 is coupled to the base portion 14 of the elongated member 12 at a position that is spatially removed from the edges of the elongated member 12.

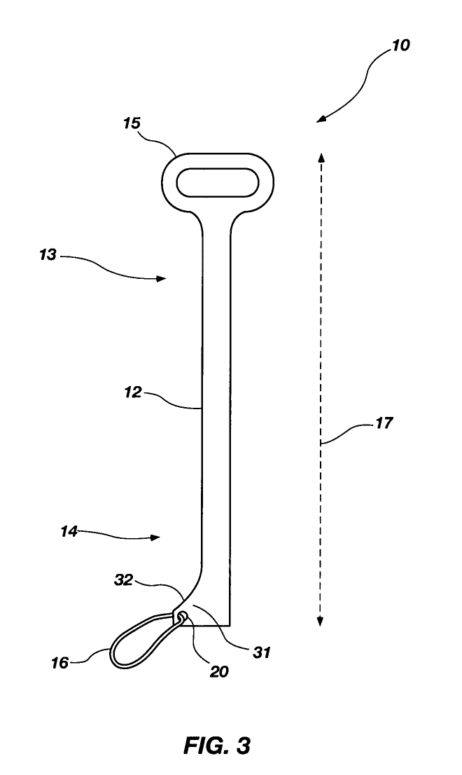

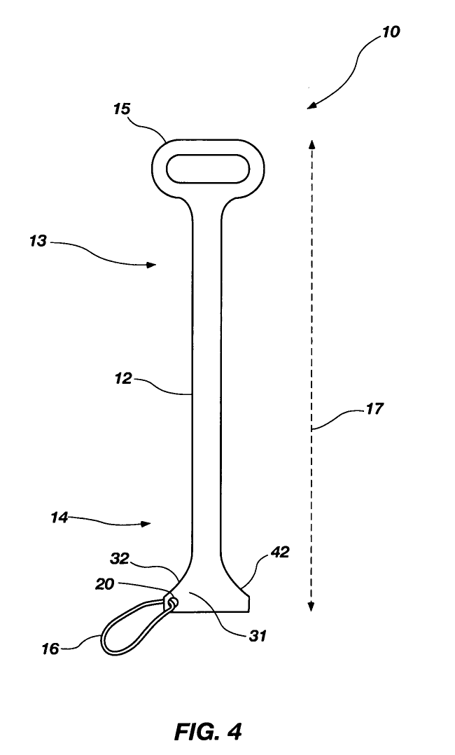

Shown in FIGS. 3 and 4, in one embodiment, the base portion 14, or at least a portion thereof, is further defined by, or includes, a cross-sectional area that is greater than the cross-sectional area of the top portion 13. It is contemplated that the greater, or increased, cross-sectional area of the base portion 14 may be embodied in any shape or size. In one non-limiting example, as shown, the greater, or increased cross-sectional area of the base portion 14, or at least a portion thereof, extends outward forming at least one protruding portion 31, or protruding member 31 that is oriented substantially orthogonal to the longitudinal plane 17. In being substantially orthogonal to the longitudinal plane 17, at least a portion of the base portion 14, or cross-sectional area thereof, need not extend or be oriented exactly orthogonal to the longitudinal plane 17.

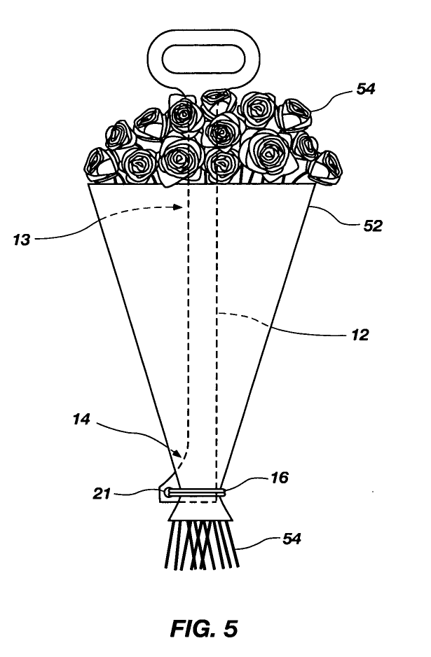

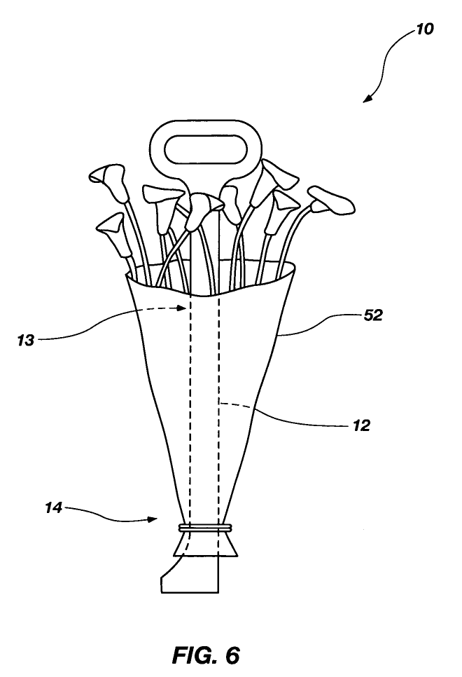

In another embodiment, shown in FIG. 3 at least a portion of the base portion 14, and protruding portion 31 thereof is defined by, or comprises, a flared first edge 32. As shown, the base portion 14 being defined by a flared first edge 32 results in a gradually increasing cross-sectional area. The illustrated flared first edge 32 may be oriented substantially orthogonal to the longitudinal plane 17 and may serve to further secure a floral grouping and its packaging elements to the elongated member 12, as shown in FIGS. 5 and 6. For example, gradually increasing the cross-sectional area of the base portion 14 decreases the distance between any packaging elements and the elongated member 12 until the packaging elements 52 are tightly abutting or pressed against the base portion 14. In this manner, packaging elements 52 such as, disposable material, may be further secured during transport and packaging.

Shown in FIG. 4, at least a portion of the base portion 14 and protruding portion 31 thereof may be defined by, or may comprise, a flared second edge 42. The flared second edge 42 may serve to further gradually increase the cross-sectional area of the base portion 14, and thus provide an additional element to secure a floral grouping and packaging elements to the elongated member 12.

Referring to FIGS. 3-5, in one embodiment, the securing member 16 is coupled to the area of greater cross-sectional area found in the base portion 14. In a non-limiting example, as shown, the securing member 16 may be coupled to the protruding portion 31. Additionally, the securing member 16 may be coupled at a position spatially removed from the first flared edge 32. As can be seen, coupling the securing member 16 to the area of greater cross sectional area or the protruding portion 31 results in the securing member 16 being coupled to the elongated member 12 away from, or otherwise outside of an exemplary positioning of a floral grouping 54 along the elongated member 12. Coupling and positioning the securing member 16 in this manner can substantially reduce or eliminate the need to search through a floral grouping 54 for the securing member 16 while attempting to position and secure a floral grouping 54. This can reduce the time necessary to secure a floral grouping 54 to the device 10, as well as limit exposure to a floral grouping which can cause injury or damage to a floral grouping 54 and/or those persons packaging or packing the floral groupings.

While the Figures illustrate that the base portion 14 includes an increased cross-sectional area, or protruding portion 31, it is contemplated any portion of the elongated member 12 may include an increased cross sectional area, or protruding portion, having a securing member 16 may be coupled thereto.

Shown in FIG. 6, the base portion 14 having a cross-sectional area greater than the top portion 13 provides additional advantages in the packaging, packing, and transporting of floral groupings. For example, in one embodiment of the invention, a floral grouping 54 is packaged having a packaging element 52, such as plastic, foil, paper, etc., wrapped around the circumference thereof. Once wrapped around a floral grouping, the packaging element 52 forms a substantially conical shape and tapers inward moving down towards the stem or bottom portions of the floral grouping 54. In one aspect, the increased cross-sectional area of the base portion 14 functions to prevent the packaging element 52 from sliding down and off the floral grouping 54 secured to the elongated member 12.

As can be seen in FIGS. 1-6, coupling the securing member 16 to the base portion 14, results in the securing member 16 being on a portion, or end, of the elongated member 12 substantially opposite to the handle 15. Advantageously, this enables a floral grouping 54 to be transported in an upright position using the handle 15 while still securing the floral grouping 54 around the stems.

It is contemplated that the device 10 may be manufactured, at least in part, as a single unit. The device 10 may be manufactured in a variety of ways, such as, but not limited to, molding, injection molding, cutting, shaping, and so forth. The device 10 may comprise a variety of materials, such as, but not limited to, paper, plastic, polyurethane, polypropylene, cardboard, and so forth. It is further contemplated that the materials may have varying levels of rigidity and thickness. In a non-limiting example, the rigidity of the material may depend upon the type and weight of the floral grouping being packaged or transported, e.g., a more rigid or thick device 10 may be used for a heavier or larger floral grouping.

It is additionally contemplated that the device 10 may be defined by varying lengths or widths. In one non-limiting example, the length of the device 10 may be dependent upon the type of floral grouping, e.g., a device 10 having an elongated member 12 of increased length may be used for larger or more lengthy floral groupings. In this manner, the position of the handle 15 may not interfere or potentially damage blossoms or flowers of a floral grouping.

In one embodiment, the device 10 may comprise an extendible or telescopic elongated member or handle. This may be accomplished in a variety of ways. In one non-limiting example, the device 10 may comprise a first and second elongated member coupled together and configured to slide against each other. In this manner, a single device may be applicable to a variety of floral groupings.

The device 10 and method provide numerous benefits and advantages to the assembly, packaging, packing, and transport of one or more floral groupings. In one exemplary embodiment, shown in FIGS. 5 and 6, a floral grouping may be positioned adjacent to the elongated member 12 with the stems or bottom portion of the floral grouping proximate to the securing member 16. It is contemplated that a floral grouping 54 may be positioned and secured proximate to the elongated member 12 such that the stem portions of the floral grouping extend beyond the bottom edge of the device 10. This may decrease the amount of area occupied by a floral group package, and may be particularly advantageous for transporting large number of floral groupings. Alternatively shown in FIG. 6, a floral grouping may be positioned and secured such that the stem portions are aligned substantially flush with a bottom edge of the device 10.

Also shown in FIGS. 5 and 6, the floral grouping may then be secured to the elongated member 16 by circumferentially wrapping the securing member 16 to the floral grouping 54. Various packaging elements 52, such as disposable material, ribbons, cards, etc. may then be placed about or around a floral grouping 54, such that, in one embodiment, the device 10 may be characterized as an insert to be used in packaging, packing, and transport of one or more floral groupings. The packaged floral grouping can then be transported by simply grasping the handle 15. Advantageously, this assists to limit or obviate the need to reach down and grasp the stem or base portion of the floral groupings. In view of this, the device 10 and method are particularly advantageous in packaging, packing, and transporting large numbers of floral groupings, such as occurs in mass market floral industries, bouquet and/or floral farms.

Although the foregoing description includes many specifics, these should not be construed as limiting the scope of the present invention but, merely, as providing illustrations of some of the presently preferred embodiments. Similarly, other embodiments of the invention may be devised which do not depart from the scope of the present invention. Features from different embodiments may be employed in combination. The scope of the invention is, therefore, indicated and limited only by the appended claims and their legal equivalents, rather than by the foregoing description. All additions, deletions and modifications to the invention as disclosed herein which fall within the meaning and scope of the claims are to be embraced thereby.

What is claimed:

1. A device for packaging or transporting a floral grouping, the device comprising:
an elongated member having a top portion and a base portion;
a handle coupled to the top portion; and
a securing member coupled to the elongated member configured to secure a floral grouping to the elongated member;
wherein the device is configured to package or transport a floral grouping.

2. The device of claim 1, wherein the elongated member is substantially equidistant along a length thereof.

3. The device of claim 1, wherein the cross-sectional area of the base portion is greater than the cross-sectional area of the top portion.

4. The device of claim 1, wherein the elongated member includes a protruding member oriented substantially orthogonal to a longitudinal plane, the longitudinal plane being parallel to the elongated member, thereby resulting in an increased cross-sectional area along the elongated member.

5. The device of claim 4, wherein the protruding member extends out from the base portion.

6. The device of claim 4, wherein the securing member is coupled to the protruding member.

7. The device of claim 4, wherein the protruding member includes a flared first edge.

8. The device of claim 1, wherein the elongated member includes a hole sized to receive the securing member.

9. The device of claim 1, wherein the handle is removably coupled to the top portion.

10. The device of claim 1, wherein the handle and the elongated member are fabricated, at least in part, as a continuous unit.

11. The device of claim 1, further comprising a floral grouping secured to the elongated member using the securing member.

12. The device of claim 11, further comprising a disposable material circumferentially wrapped around the floral grouping.

13. A device for packaging or transporting a floral grouping, the device comprising:
an elongated member having a top portion and a base portion, the elongated member including protruding member oriented substantially orthogonal to a longitudinal plane, the longitudinal plane being parallel to the elongated member, thereby resulting in an increased cross-sectional area along the elongated member relative to the top portion;
a handle coupled to the top portion; and
a securing member coupled to the elongated member and configured to secure a floral grouping to the elongated member;
wherein the device is configured to package or transport a floral grouping.

14. The device of claim 13, wherein the securing member is coupled to the protruding member.

15. A method for packaging or transporting a floral grouping comprising:
providing an elongated member having a handle coupled to a top portion of the elongated member;
positioning a floral grouping adjacent to the elongated member; and
wrapping a securing member coupled to the elongated member circumferentially around the floral grouping such that the floral grouping is securely coupled to the elongated member.

16. The method of claim 15, wherein the securing member is coupled to a base portion of the elongated member.

17. The method of claim 14, further comprising circumferentially wrapping the floral grouping in a disposable material.

18. A method for manufacturing a floral group packaging device, the method comprising:
providing an elongated member defined by a top portion and a base portion, the elongated member sized to transport or package a floral grouping;
coupling a handle to the top portion; and
coupling a securing member to the base portion.

19. The method of claim 18, further comprising forming the base portion such that the base portion is defined by a cross-sectional area greater than the top portion.

20. The method of claim 19, further comprising forming the base portion such that the base portion is further defined by a protruding first edge oriented substantially orthogonal to the longitudinal plane

21. The method of claim 18, further comprising fabricating the elongated member and the handle as a single unit.
